(19) United States
(12) Patent Application Publication
(10) Pub. No.: US 2023/0083842 A1
(43) Pub. Date: Mar. 16, 2023

(54) ESTIMATION METHOD, ESTIMATION APPARATUS AND PROGRAM

(71) Applicant: NIPPON TELEGRAPH AND TELEPHONE CORPORATION, Tokyo (JP)

(72) Inventors: Masahiro KOJIMA, Tokyo (JP); Masami TAKAHASHI, Tokyo (JP); Takeshi KURASHIMA, Tokyo (JP); Hiroyuki TODA, Tokyo (JP)

(73) Assignee: NIPPON TELEGRAPH AND TELEPHONE CORPORATION, Tokyo (JP)

(21) Appl. No.: 17/798,062

(22) PCT Filed: Feb. 6, 2020
(86) PCT No.: PCT/JP2020/004535

§ 371 Date: Aug. 5, 2022

(51) Int. Cl. G06N 20/20; G06K 9/62

(52) U.S. Cl. CPC G06N 20/20; G06K 9/6298

(57) ABSTRACT

An estimation apparatus according to one embodiment is an estimation method for estimating a parameter of a model for obtaining a state transition probability used in model-based reinforcement learning and causes a computer to perform: an input procedure in which first data indicating a state transition history in a situation where an action of the model-based reinforcement learning is not performed and second data indicating, when an action prompting a transition to a predetermined state is performed, a degree of accepting the transition to the predetermined state are input; and an estimation procedure in which a parameter of the model is estimated by using the first data and the second data.

### TECHNICAL FIELD

The present invention relates to an estimation method, an estimation apparatus, and a program.

### BACKGROUND ART

In recent years, a method called reinforcement learning (RL) has yielded significant results in the field of game AI (Artificial Intelligence) in computer games, Go, or the like (for example, Non Patent Literatures 1 and 2). Following the trend of this success, further studies have been conducted in the classical application fields, such as robot control and adaptive control of traffic lights, and the applicable fields are expanding to various fields such as recommender systems and healthcare (for example, Non Patent Literatures 3 and 4). Further, in recent years, research has been conducted on a method called entropy-regularized RL in which a regularization term regarding a policy is introduced into an objective function (for example, Non Patent Literature 5).

Reinforcement learning methods can be broadly classified into two types of methods: model-free RL and model-based RL. A typical method of model-free RL is Q-learning (for example, Non Patent Literature 6) in which a value function representing the sum of rewards obtained in the future is directly estimated by using data obtained from interaction with an environment. Whereas in the model-based RL, first, parameters of an environment, such as a state transition probability, are estimated, and then, a value function is estimated by using the estimated parameters.

It is known that a trade-off between a calculation amount/memory capacity and estimation performance typically exists between the model-free RL and the model-based RL (for example, Non Patent Literature 7). In the model-free RL, data once used for estimation is basically discarded, and only a value function (or a parameter thereof) is stored. In contrast, in the model-based RL, all the data is stored, and then, a parameter of the environment is estimated. Thus, while the model-based RL needs a larger memory capacity than the model-free RL, the model-based RL is more likely to achieve higher estimation performance than the model-free RL especially when the number of available data is small. Therefore, the model-free RL is more frequently used for robot control and the like, whereas the model-based RL is often used in a case where available data is limited, such as a start-up stage of a recommender system service.

Estimating a state transition probability by the model-based RL needs data (hereinafter, referred to as “intervention transition data”) that is composed of a set of tuples of a pre-transition state, an action, and a post-transition state and obtained in a situation where an action (that is, intervention from a system) is performed. When such intervention transition data is available and the state and the action are both discrete, a state transition probability can be estimated by counting the number of times that a certain state has transitioned to a next state due to a certain action. As the state and action, for example, in a case of a recommender system, the state may be “the page of an item that a user is viewing”, and the action may be “presentation of a recommended item”. In a case of a healthcare application, for example, the state may be an activity that a user is performing such as “housework” or “work”, and the action may be “notification from the system” (for example, notification to the user such as “why don't you go to work?” or “why don't you take a break?”).

### CITATION LIST

### Non Patent Literature

[NPL 1] Volodymyr Mnih, Koray Kavukcuoglu, David Silver, Andrei A. Rusu, Joel Veness, Marc G. Bellemare, Alex Graves, Martin Riedmiller, Andreas K. Fidjeland, Georg Ostrovski, Stig Petersen, Charles Beattie, Amir Sadik, Ioannis Antonoglou, Helen King, Dharshan Kumaran, Daan Wierstra, Shane Legg, and Demis Hassabis. Human-level control through deep reinforcement learning. Nature, 518(7540):529-533, 2015.
[NPL 2] David Silver, Aja Huang, Chris J. Maddison, Arthur Guez, Laurent Sifre, George vanden Driessche, Julian Schrittwieser, Ioannis Antonoglou, Veda Panneershelvam, Marc Lanctot, Sander Dieleman, Dominik Grewe, John Nham, Nal Kalchbrenner, Ilya Sutskever, Timothy Lillicrap, Madeleine Leach, Koray Kavukcuoglu, Thore Graepel, and Demis Hassabis. Mastering the game of go with deep neural networks and tree search. Nature, 529:484-489, 2016.
[NPL 3] Aliel Hassouni, Mark Hoogendoorn, Martijn van Otterlo, and Eduardo Barbaro. Personalization of health interventions using cluster-based reinforcement learning. In Principles and Practice of Multi-Agent Systems, pages 467-475, 2018.
[NPL 4] Guy Shani, David Heckerman, and Ronenl Brafman. An mdp-based recommender system. Journal of Machine Learning Research, 6(September):1265-1295, 2005.
[NPL 5] Tuomas Haarnoja, Haoran Tang, Pieter Abbeel, and Sergey Levine. Reinforcement learning with deep energy-based policies. In Proceedings of the 34th International Conference on Machine Learning-Volume 70, pages 1352-1361. JMLR. org, 2017.
[NPL 6] Christopher J C H Watkins and Peter Dayan. Q-learning. Machine learning, 8(3-4):279-292, 1992.
[NPL 7] Christopher G Atkeson and Juan Carlos Santamaria. A comparison of direct and model-based reinforcement learning. In Proceedings of International Conference on Robotics and Automation, volume 4, pages 3557-3564. IEEE, 1997.

### SUMMARY OF THE INVENTION

### Technical Problem

However, when the model-based RL is applied to practical matters, there are cases in which, while data (hereinafter, referred to as “non-intervention transition data”) collected in a situation where an action is not performed is available, intervention transition data is not available. For example, in the case of the recommender system, such a case corresponds to a situation where there is only data (non-intervention transition data) composed of a set of tuples of pre-transition states and post-transition states of a user obtained when the function of presenting a recommended item to the user is not yet available. Further, for example, in the case of the healthcare application, such a case corresponds to a situation where there is only data (non-intervention transition data) composed of tuples of pre-transition states and post-transition states of a user obtained when the system has no function of providing notification to the user.

With only such non-intervention transition data, it is impossible to estimate a next state to transition into when a certain action (for example, the system intervention such as the presentation of a recommended item and the notification to the user) is performed. Thus, when intervention transition data is not available, the conventional model-based RL cannot estimate a state transition probability.

With the foregoing in view, it is an object of one embodiment of the present invention to estimate a state transition probability by using data collected in a situation where a system does not intervene in the user.

### Means for Solving the Problem

To achieve the above object, an estimation apparatus according to one embodiment is an estimation method for estimating a parameter of a model for obtaining a state transition probability used in model-based reinforcement learning and causes a computer to perform: an input procedure in which first data indicating a state transition history in a situation where an action of the model-based reinforcement learning is not performed and second data indicating, when an action prompting a transition to a predetermined state is performed, a degree of accepting the transition to the predetermined state are input; and an estimation procedure in which a parameter of the model is estimated by using the first data and the second data.

### Effects of the Invention

A state transition probability can be estimated by using data collected in a situation where a system does not intervene in the user.

### BRIEF DESCRIPTION OF DRAWINGS

FIG. 1 illustrates an example of a functional configuration of an estimation apparatus according to the present embodiment.

FIG. 2 is a flowchart illustrating an example of estimation processing according to the present embodiment.

FIG. 3 illustrates an example of a hardware configuration of the estimation apparatus according to the present embodiment.

### DESCRIPTION OF EMBODIMENTS

Hereinafter, one embodiment of the present invention will be described. In the present embodiment, an estimation apparatus 10 capable of estimating a state transition probability (hereinafter, simply referred to as a “transition probability”) used in model-based RL by using data (non-intervention transition data) collected in a situation where some kind of system such as a recommender system or a healthcare application does not intervene in a user will be described. When estimating the transition probability, the estimation apparatus 10 according to the present embodiment uses not only the non-intervention transition data but also transition acceptance data. The transition acceptance data is data indicating a degree to which the user can accept the intervention of the system (for example, a probability of accepting the intervention of the system). In other words, the transition acceptance data is a degree indicating whether the user prompted to transition to a certain state by a certain action (that is, the intervention of the system) accepts the transition to the state. Such transition acceptance data may be collected, for example, by questionnaires to users.

For example, in the case of the recommender system, the transition acceptance data is data indicating a degree to which, in response to an action of the system that “presents item 1 and item 2 as recommended items”, the user accepts the action and allows the state to transition to a state of “viewing “the page of item 1”” or “viewing “the page of item 2””. Further, for example, in the case of the healthcare application, the transition acceptance data is data indicating a degree to which, in response to an action of the system. that “notifies “why don't you go to work?””, the user accepts the action and allows the state to transition to a state of “going to work”.

<Preparation>

First, concepts, terms, etc., used in the present embodiment will be described.

<<Reinforcement Learning (RL)>>

Reinforcement learning is a method in which a learner (agent) estimates an optimal action rule (policy) through interaction with an environment. In reinforcement learning, a Markov decision process (MDP) is often used for setting the environment. In the present embodiment as well, the environment is set by a Markov decision process.

A Markov decision process is defined by a 4-tuple (S, A, P, R). S is called state space, and A is called action space. Respective elements, s∈S and a∈A, are called states and actions, respectively. P:S×A×S→[0,1] is called a state transition function and determines a transition probability that an action a performed in a state s leads to a next state s′.

Further, the following represents a reward function.

R:S×A→ [symbol] [Math. 1]

The reward function defines a reward obtained when the action a is performed in the state s. The agent performs the action such that the sum of rewards obtained in the future in the above environment is maximized. The determined probability that the agent selects the action a in each state s is called a policy π:S×A→[0,1]. When a time-inhomogeneous Markov decision process in which the transition probability and the reward function vary at each time t is considered, the state transition function and the reward function may be defined as {Pₜ}ₜ, {Rₜ}ₜ at each time.

<<Value Function>>

Once one policy is defined, the agent can perform interaction with the environment. The agent in a state sₜ determines (selects) an action aₜ at each time t in accordance with a policy π(·|sₜ). Next, in accordance with a state transition function and a reward function, a state sₜ₊₁ to P(·|sₜ,aₜ) of the agent and a reward rₜ=R(sₜ,aₜ) at the next time are determined. By repeating this determination, a history of the states and actions of the agent is obtained. Hereinafter, the history of the states and actions (s₀·a₀, s₁·a₁, . . . , s_{T}·a_{T}) obtained by repeating the transition T times from time t=0 to t=T is denoted as d_{T}, which is called an episode.

Here, a value function is defined as a function serving to represent how good the policy is. The value function is defined as the average of returns obtained when the action a is selected in the state s and then continues to be performed in accordance with the policy π. When a finite time period (finite horizon) is considered, the sum total of rewards is used as the return, and when an infinite time period (infinite horizon) is considered, the sum of discounted rewards is used as the return. Evaluation functions are expressed by mathematical formula (1) and mathematical formula (2) below.

$$\begin{matrix}[ Math . 2 ] & \\ finite horizon : {Q}^{π} ( s , a ) = {𝔼}_{{d}_{T}}^{π} [ {\sum }_{k = 0}^{T} R ( {s}_{k} , {a}_{k} ) \vert {s}_{0} = s , {a}_{0} = a ] & ( 1 )\end{matrix}$$

$$infinite horizon : {Q}^{π} ( s , a ) = {lim}_{T \to ∞} {𝔼}_{{d}_{T}}^{π} [ {\sum }_{k = 0}^{T} {γ}^{k} R ( {s}_{k} , {a}_{k} ) \vert {s}_{0} = s , {a}_{0} = a ] \qquad ( 2 )$$

A discount rate is represented by γ∈[0,1), and an average operation related to how the episode appears by the policy π is represented as below.

[symbol]

_{d}_{_{T}}^{π}[ ] [Math. 3]

Hereinafter, for simplicity, the case of infinite horizon will be considered.

When certain policies π and π′ satisfy Q^{π}(s,a)≥Q^{π′}(s,a) with random s∈S, a∈A, it can be expected that the policy π provides the agent with more rewards than the policy π′. This is denoted as π≥π′. An object of reinforcement learning is to obtain an optimal policy π* that satisfies π*≥π for a random policy π.

The optimal policy π* can be obtained by setting π*(a|s)=δ(a−argmax_{a′}Q*(s,a′)) using a value function Q* thereof. The above value function is called an optimal value function. Note that δ(·) is a delta function, and when δ(0), 1 is obtained, and otherwise, 0 is obtained.

It is known that an optimal value function Q* in the case of infinite horizon satisfies an optimal Bellman equation indicated by the following mathematical formula (3).

$$\begin{matrix}[ Math . 4 ] & \\ {Q}^{*} ( s , a ) = {𝔼}_{{s}^{′}} [ R ( s , a ) + {γmax}_{{a}^{′}} {Q}^{*} ( {s}^{′} , {a}^{′} ) ] & ( 3 )\end{matrix}$$

Therefore, if the environment (that is, the transition probability and reward function) is known, a value of the optimal value function Q* can be obtained by value iteration using the optimal Bellman equation indicated in the above mathematical formula (3). More commonly, if the environment is known, any desired method in which an optimal policy is obtained by the Markov decision process such as policy iteration can be used. The same applies to the case of finite horizon. While the common reinforcement learning has been described herein, the transition probability estimated by the estimation apparatus 10 according to the present embodiment can also be used in entropy-regularized RL or the like.

<Theoretical Configuration>

Next, a theoretical configuration of the method in which the estimation apparatus 10 according to the present embodiment estimates a transition probability will be described. Hereinafter, a case of estimating a transition probability in a time-inhomogeneous Markov decision process in which the transition probability varies depending on time will be described. However, the transition probability can also be estimated in a common-used time-homogeneous Markov decision process by using a similar framework.

<<Prior Knowledge about Action>>

In the present embodiment, it is assumed that prior knowledge about a state to which each action prompts the transition is already obtained. Such prior knowledge is available in the case of the recommender system and the healthcare application described above. For example, in the case of the recommender system, the action of the system that “presents item 1 and item 2 as recommended items” can be interpreted as an action to prompt the user to transition to a state of “viewing “the page of item 1”” or “viewing “the page of item 2””. Likewise, for example, in the case of the healthcare application, the action of the system that “notifies “why don't you go to work?”” can be interpreted as an action to prompt the user to transition to a state of “going to work”. Hereinafter, a set of destination states to which the action a prompts the user to transition is denoted as Uₐ. Using this prior knowledge can reduce the number of parameters of a model (probability estimation model), which will be described below, so that accurate estimation can be performed. In a case where the number of states and the number of actions are small or in a case where a large amount of data (non-intervention transition data and transition acceptance data) is obtained, the estimation can be performed without this prior knowledge.

In the following description, for convenience, the transition probability is estimated assuming that the Markov decision process includes an action of “no intervention”. If a Markov decision process which does not include an action of “no intervention” is considered, the estimation result of the transition probability corresponding to such an action may not be used.

<<Data Used for Estimating Transition Probability>>

Non-intervention transition data is denoted as Bₜᵣ, and transition acceptance data is denoted as Bₐₚₜ. The non-intervention transition data Bₜᵣ indicates a state transition history obtained when no action is performed and is defined as Bₜᵣ=Nₜᵢⱼ indicates the number of times that a state i has transitioned to a state j at time t. For example, in the case of the recommender system, the non-intervention transition data Bₜᵣ indicates a state transition history of the user (or information obtained by aggregating such a history, for example) obtained when the function of presenting a recommended item to the user is not yet available. Likewise, for example, in the case of the healthcare application, the non-intervention transition data Bₜ, indicates a state transition history of the user (or information obtained by aggregating such a history, for example) obtained when the system has no function of providing notification to the user.

The transition acceptance data Bₐₚₜ indicates a degree to which, when a certain action (that is, intervention of the system) prompts the user to transition to a certain state, the user accepts the transition to the state. As described above, the transition acceptance data Bₐₚₜ may be collected through a questionnaire or the like, and the questionnaire is conducted in any one of the following (format 1) to (format 3) based on the collection method.

(Format 1)

A case where the user is asked whether a specific action can be accepted when in a certain state: this format corresponds to, for example, a case where, while viewing the page of a certain item, the user is asked whether to accept a suggestion about transitioning to another page of a specific item.

In this case, the transition acceptance data Bₐₚₜ can be expressed as below.

Bₐₚₜ={(s_{d},a_{d},β_{d})}_{d=1}^{D}

D represents a transition acceptance degree included in Bₐₚₜ, and each (s_{d},a_{d},β_{d}) represents transition acceptance.

Each (s_{d},a_{d},β_{d}) indicates that, when in the state s_{d}, the user accepts the transition to any one of the states that belong to a set indicated in Math. 6 by the action a_{d} at the probability β_{d}.

Uₐ_{_{d}} [Math. 6]

Note that β_{d} is 0≤β_{d}≤1, and this probability β_{d} may be a subjective view (or a value based on the subjective view) of the user collected by the questionnaire or the like.

(Format 2)

A case where the user is asked whether a specific action can be accepted at certain time: this format corresponds to, for example, a case where the user is asked whether to accept a suggestion about transitioning to the page of a specific item at certain time.

In this case, the transition acceptance data Bₐₚₜ can be expressed as below.

Bₐₚₜ={(t_{d},a_{d},β_{d})}_{d=1}^{D}[Math. 7]

Each (t_{d},a_{d},β_{d}) represents transition acceptance and indicates that the user accepts the transition to any one of the states that belong to a set indicated in Math. 8 at the time t_{d} by the action a_{d} at the probability β_{d}.

Uₐ_{_{d}}[Math. 8]

(Format 3)

A case where the user is asked whether a specific action can be accepted when in a certain state at certain time: this format corresponds to, for example, a case where, while viewing the page of a certain item at certain time, the user is asked whether to accept a suggestion about transitioning to another page of a specific item.

In this case, the transition acceptance data Bₐₚₜ is expressed as below.

Bₐₚₜ={(t_{d},s_{d},β_{d})}_{d=1}^{D} [Math. 9]

Each (t_{d}, s_{d}, a_{d}, β_{d}) represents transition acceptance and indicates that, when in the state s_{d} at the time t_{d}, the user accepts the transition to any one of the states that belong to a set indicated in Math. 10 by the action a_{d} at the probability β_{d}.

Uₐ_{_{d}} [Math. 10]

Hereinafter, for simplicity, the transition acceptance data Bₐₚₜ described above in (Format 3) is assumed to be given. However, the present embodiment is also applicable in a similar manner to the case where the transition acceptance data Bₐₚₜ described above in (Format 1) or (Format 2) is given.

Next, statistics Mₜᵢₖ and Gₜᵢₖ are defined by the following mathematical formulas using the transition acceptance data Bₐₚₜ.

Mₜᵢₖ=Σ_{{d|t}_{_{d}}_{=t,s}_{_{d}}_{=i,a}_{_{d}}_{=k}}β_{d}

Gₜᵢₖ=Σ_{d=1}^{D}1(t_{d}=t,s_{d}=i,a_{d}=k) [Math. 11]

Note that 1(·) is an indicator function, and when a condition X is true, 1(X)=1, and otherwise, 1(X)=0.

The above statistic Mₜᵢₖ indicates the sum of probabilities β_{d} where the time t_{d}=t, the state s_{d}=i, and the action a_{d}=a. The statistic Gₜᵢₖ indicates the transition acceptance degree where the time t_{d}=t, the state s_{d}=i, and the action a_{d}=a.

In addition, the non-intervention transition data Bₜᵣ and the transition acceptance data Bₐₚₜ are collectively denoted as B. That is, B=Bₜᵣ∪Bₐₚₜ

<<Model and Algorithm>>

Any model can be used as a model (hereinafter, referred to as a “probability estimation model”) for estimating a transition probability.

A parameter (hereinafter, referred to as a “model parameter”) of the probability estimation model is denoted as θ={u,v}, and the probability estimation model is represented as below to clarify dependency on the model parameter θ.

{Pₜ^{θ}} [Math. 12]

In the present embodiment, a model based on a log-linear model is constructed as the probability estimation model.

As modeling policies, a transition probability of not performing any action (that is, performing the action of “no intervention”) is expressed by using a parameter v, and an impact of each action on the transition probability of not performing any action is expressed by using a parameter u. With these parameters, for example, probability estimation models described in (a) to (c) below can be obtained.

(a) When the effect of the action depends only on the current state: by using parameters v={v_{tig}}, u={uᵢₖⱼ}, the probability estimation model is defined as below. The effect of the action refers to how much the action affects the transition probability (in other words, the degree of contribution of the action to the transition probability).

$$[ Math . 13 ]$$

$${P}_{t}^{θ} ( {s}_{t + 1} = j \vert {s}_{t} = i , a = k ) = \{ \begin{matrix}\frac{exp ( {v}_{tij} )}{{\sum }_{{j}^{′}} exp ( {v}_{{tij}^{′}} )} & ( if k = {a}_{noitv} : no intervention ) \\ \frac{exp ( {v}_{tij} + {u}_{ikj} )}{\begin{matrix}{\sum }_{{j}^{′} ∈ {U}_{k}} exp ( {v}_{{tij}^{′}} + {u}_{{ikj}^{′}} ) + \\ {\sum }_{{j}^{″} ∉ {U}_{k}} exp ( {v}_{{tij}^{″}} )\end{matrix}} & ( if j ∈ {U}_{k} , k \neq {a}_{noitv} ) \\ \frac{exp ( {v}_{tij} )}{\begin{matrix}{\sum }_{{j}^{′} ∈ {U}_{k}} exp ( {v}_{{tij}^{′}} + {u}_{{ikj}^{′}} ) + \\ {\sum }_{{j}^{″} ∉ {U}_{k}} exp ( {v}_{{tij}^{″}} )\end{matrix}} & ( if j ∉ {U}_{k} , k \neq {a}_{noitv} )\end{matrix}$$

Here, aₙₒᵢₜᵥ represents an action of “no intervention”.

(b) When the effect of the action depends only on the current time: by using parameters v={vₜᵢⱼ}, u={uₜₖⱼ}, the probability estimation model is defined as below.

$$[ Math . 14 ]$$

$${P}_{t}^{θ} ( {s}_{t + 1} = j \vert {s}_{t} = i , a = k ) = \{ \begin{matrix}\frac{exp ( {v}_{tij} )}{{\sum }_{{j}^{′}} exp ( {v}_{{tij}^{′}} )} & ( if k = {a}_{noitv} : no intervention ) \\ \frac{exp ( {v}_{tij} + {u}_{tkj} )}{\begin{matrix}{\sum }_{{j}^{′} ∈ {U}_{k}} exp ( {v}_{{tij}^{′}} + {u}_{{tkj}^{′}} ) + \\ {\sum }_{{j}^{″} ∉ {U}_{k}} exp ( {v}_{{tij}^{″}} )\end{matrix}} & ( if j ∈ {U}_{k} , k \neq {a}_{noitv} ) \\ \frac{exp ( {v}_{tij} )}{\begin{matrix}( {\sum }_{{j}^{′} ∈ {U}_{k}} exp ( {v}_{{tij}^{′}} + {u}_{{tkj}^{′}} ) + \\ {\sum }_{{j}^{″} ∉ {U}_{k}} exp ( {v}_{{tij}^{″}} )\end{matrix}} & ( if j ∉ {U}_{k} , k \neq {a}_{noitv} )\end{matrix}$$

(c) When the effect of the action depends on the current state and the current time: by using parameters v=u={vₜᵢⱼ}, u={uₜᵢₖⱼ}, the probability estimation model is defined as below.

$$[ Math . 15 ]$$

$${P}_{t}^{θ} ( {s}_{t + 1} = j \vert {s}_{t} = i , a = k ) = \{ \begin{matrix}\frac{exp ( {v}_{tij} )}{{\sum }_{{j}^{′}} exp ( {v}_{{tij}^{′}} )} & ( if k = {a}_{noitv} : no intervention ) \\ \frac{exp ( {v}_{tij} + {u}_{tikj} )}{\begin{matrix}{\sum }_{{j}^{′} ∈ {U}_{k}} exp ( {v}_{{tij}^{′}} + {u}_{{tikj}^{′}} ) + \\ {\sum }_{{j}^{″} ∉ {U}_{k}} exp ( {v}_{{tij}^{″}} )\end{matrix}} & ( if j ∈ {U}_{k} , k \neq {a}_{noitv} ) \\ \frac{exp ( {v}_{tij} )}{\begin{matrix}{\sum }_{{j}^{′} ∈ {U}_{k}} exp ( {v}_{{tij}^{′}} + {u}_{{tikj}^{′}} ) + \\ {\sum }_{{j}^{″} ∉ {U}_{k}} exp ( {v}_{{tij}^{″}} )\end{matrix}} & ( if j ∉ {U}_{k} , k \neq {a}_{noitv} )\end{matrix}$$

While the present embodiment is applicable to a probability estimation model other than the probability estimation model defined in the above (a) to (c), the following description will be made by using the probability estimation model defined in any one of the above (a) to (c).

The model parameter θ can be estimated by optimizing an objective function. Here, if non-intervention transition data is regarded as intervention transition data obtained when the action aₙₒᵢₜᵥ, which indicates “no intervention”, is performed, a generation probability of the non-intervention transition data is given by the following mathematical formula.

p(Bₜᵣ|θ)=Πₜ₌₁^{T}Π_{i,j∈S}(Pₜ^{θ}(sₜ₊₁=j|sₜ=i,a=aₙₒᵢₜᵥ))^{N}^{ₜᵢⱼ} [Math. 16]

Further, by using the transition acceptance (t_{d}, s_{d}, a_{d}, β_{d}), which is regarded as indicating the number of times that the state s_{d} has transitioned to the state indicated in Math. 17 below for β_{d} times by the action a_{d} at the time t_{d}, the generation probability of the transition acceptance data is given by the following mathematical formula indicated in Math. 18 below.

j∈Uₐ_{_{d}} [Math. 17]

$$[ Math . 18 ]$$

$$\begin{matrix}p ( {B}_{apt} \vert θ ) = {{\prod }_{d = 1}}^{D} \{ {( {\sum }_{j ∈ {U}_{k}} {P}_{{t}_{d}}^{θ} ( {s}_{t + 1} = j \vert {s}_{t} = {s}_{d} , a = {a}_{d} ) )}^{ {β}_{d}} \\ {( 1 - {\sum }_{j ∈ {U}_{k}} {P}_{{t}_{d}}^{θ} ( {s}_{t + 1} = j \vert {s}_{t} = {s}_{d} , a = {a}_{d} ) )}^{( 1 - {β}_{d} )} \} \\ = {{\prod }_{t = 1}}^{T} {\prod }_{i ∈ S} {\prod }_{k ∈ A} \{ {( {\sum }_{j ∈ {U}_{k}} {P}_{t}^{θ} ( {s}_{t + 1} = j \vert {s}_{t} = i , a = k ) )}^{{M}_{tik}} \\ {( 1 - {\sum }_{j ∈ {U}_{k}} {P}_{{t}_{d}}^{θ} ( {s}_{t + 1} = j \vert {s}_{t} = i , a = k ) )}^{{G}_{tik} - {M}_{tik}} \}\end{matrix}$$

In this way, a negative log-likelihood function represented by the sum of encoded and judged logarithms obtained from each of the non-intervention transition data generation probability p(Bₜᵣ|θ) and the intervention transition data generation probability p(Bₐₚₜ|θ) is obtained, and this negative log-likelihood function can serve as an objective function. That is, for example, L(θ)=−log(p(Bₜᵣ|θ))−ν log(p(Bₐₚₜ|θ))+λΩ(θ) can be an objective function. Note that a regularization term Ω(θ) is added in the above objective function to prevent over training. For example, as the regularization term, any regularization term such as an L₂ norm can be used. Further, ν and λ are hyperparameters.

The model parameter θ is estimated by minimizing the above objective function L(θ).

That is, the model parameter is estimated by the following equation.

\hat{θ}=argmin_{θ}L(θ) [Math. 19]

For convenience, in the text of the description, the model parameter obtained as the estimation result is denoted as “\hat{ }θ”. Further, a desired optimization method such as a gradient method, a Newton method, an auxiliary function method, or an L-BFGS method may be used to minimize (optimize) the objective function L(θ). In this way, the transition probability can be estimated by using the transition probability model using the model parameter \hat{ }θ.

<Functional Configuration>

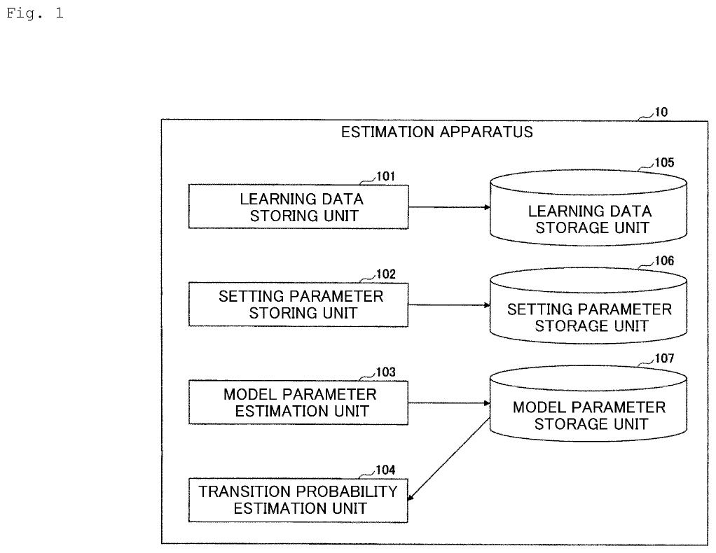

Next, a functional configuration of the estimation apparatus 10 according to the present embodiment will be described with reference to FIG. 1. FIG. 1 illustrates an example of a functional configuration of the estimation apparatus 10 according to the present embodiment.

As illustrated in FIG. 1, the estimation apparatus 10 according to the present embodiment includes a learning data storing unit 101, a setting parameter storing unit 102, a model parameter estimation unit 103, a transition probability estimation unit 104, a learning data storage unit 105, a setting parameter storage unit 106, and a model parameter storage unit 107.

The learning data storing unit 101 stores the given non-intervention transition data Bₜᵣ and transition acceptance data Bₐₚₜ in the learning data storage unit 105 as learning data B=Bₜᵣ∪Bₐₚₜ. For example, the non-intervention transition data Bₜᵣ and the transition acceptance data Bₐₚₜ may be acquired from a server device or the like connected to the estimation apparatus 10 via a communication network and given to the learning data storing unit 101.

The setting parameter storing unit 102 stores the given setting parameters (for example, the parameter representing the model used as a probability estimation model, the hyperparameters ν and λ, etc.) in the setting parameter storage unit 106. For example, the setting parameters may be specified by the user and given to the setting parameter storing unit 102.

The model parameter estimation unit 103 estimates a model parameter θ of the probability estimation model by using the learning data B and the setting parameters. Next, the model parameter estimation unit 103 stores the estimated model parameter \hat{ }θ in the model parameter storage unit 107.

The transition probability estimation unit 104 estimates a state transition probability by the probability estimation model using the model parameter \hat{ }θ.

FIG. 1 illustrates the functional configuration example in which the same apparatus estimates the model parameter of the probability estimation model and the transition probability. Alternatively, for example, the estimation of the model parameter of the probability estimation model and the estimation of the transition probability may be performed by different apparatuses. In that case, the model parameter estimation unit 103 and the transition probability estimation unit 104 may be arranged in different apparatuses.

<Estimation Processing>

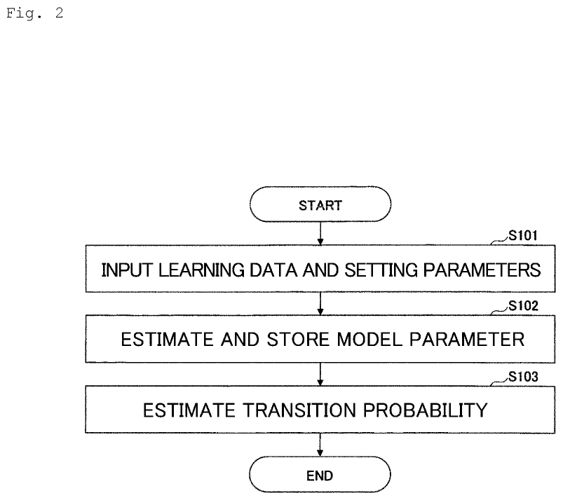

Next, the processing in which the estimation apparatus 10 according to the present embodiment estimates a model parameter \hat{ }θ and then estimates a transition probability by using the model parameter \hat{ }θ will be described with reference to FIG. 2. FIG. 2 is a flowchart illustrating an example of the estimation processing according to the present embodiment.

First, the model parameter estimation unit 103 inputs the learning data B stored in the learning data storage unit 105 and the setting parameters stored in the setting parameter storage unit 106 (step S101).

Next, the model parameter estimation unit 103 estimates a model parameter θ of the probability estimation model by using the learning data B and the setting parameters and stores the estimated model parameter \hat{ }θ in the model parameter storage unit 107 (step S102). In this step, for example, the model parameter estimation unit 103 may use any one of the probability estimation models defined in the above (a) to (c) and estimates the model parameter \hat{ }θ by minimizing the above-described objective function L(θ) using any desired optimization method.

Next, the transition probability estimation unit 104 estimates a state transition probability by the probability estimation model using the model parameter \hat{ }θ stored in the model parameter storage unit 107 (step S103). In this way, the state transition probability used in the model-based RL is estimated.

The model parameter \hat{ }θ estimated in the above step S102 and the state transition probability estimated in the above step S103 may be output to any desired output destination. For example, when the apparatus estimating the model parameter and the apparatus estimating the state transition probability are different apparatuses, the model parameter estimation unit 103 may output (transmit) the model parameter \hat{ }θ to the apparatus estimating the state transition probability. In addition, for example, when the apparatus estimating the state transition probability and the apparatus estimating a value function of the model-based RL are different apparatuses, the transition probability estimation unit 104 may output (transmit) the state transition probability to the apparatus estimating the value function.

As described above, when the intervention transition data is not available, the estimation apparatus 10 according to the present embodiment can estimate a state transition probability of the Markov decision process by using the non-intervention transition data and the transition acceptance data. In this way, even in a situation where, for example, in construction of a recommender system, the only data available is the state transition history of the user obtained when the function of presenting a recommended item to the user is not yet available or a situation where, in a healthcare application, the only data available is the state transition history of the user obtained when the user notification function is not yet available, the estimation apparatus 10 according to the present embodiment is capable of estimating a state transition probability by collecting the transition acceptance data.

<Hardware Configuration>

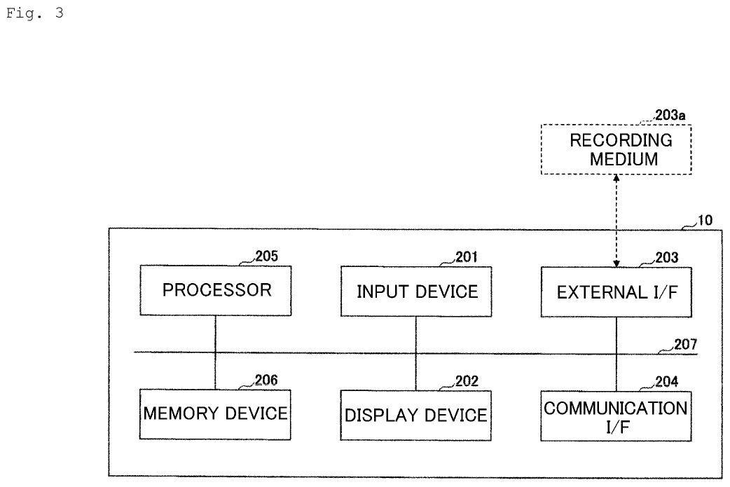

Finally, a hardware configuration of the estimation apparatus 10 of the present embodiment will be described with reference to FIG. 3. FIG. 3 illustrates an example of the hardware configuration of the estimation apparatus 10 according to the present embodiment.

As illustrated in FIG. 3, the estimation apparatus 10 according to the present embodiment is a common computer or computer system and includes an input device 201, a display device 202, an external I/F 203, a communication I/F 204, a processor 205, and a memory device 206. These hardware components are connected via a bus 207 so as to be able to communicate with each other.

The input device 201 is, for example, a keyboard, a mouse, a touch panel, or the like. The display device 202 is, for example, a display or the like. The estimation apparatus 10 may not include at least one of the input device 201 and the display device 202.

The external I/F 203 is an interface to an external device. The external device includes a recording medium 203a or the like. The estimation apparatus 10 can read from and write to the recording medium 203a via the external I/F 203, for example. For example, the recording medium 203a may store at least one program that implements each of the functional units (the learning data storing unit 101, the setting parameter storing unit 102, the model parameter estimation unit 103, and the transition probability estimation unit 104) included in the estimation apparatus 10.

Examples of the recording medium 203a include a CD (Compact Disc), a DVD (Digital Versatile Disc), an SD memory card (Secure Digital memory card), and a USB (Universal Serial Bus) memory card.

The communication I/F 204 is an interface for connecting the estimation apparatus 10 to a communication network. At least one program that implements the functional units included in the estimation apparatus 10 may be acquired (downloaded) from a predetermined server device or the like via the communication I/F 204.

Examples of the processor 205 include various computing devices such as a CPU (Central Processing Unit) and a GPU (Graphics Processing Unit). Each functional unit included in the estimation apparatus 10 is implemented by the processor 205 executing at least one program stored in the memory device 206.

Examples of the memory device 206 include various storage devices such as an HDD (Hard Disk Drive), an SSD (Solid State Drive), a RAM (Random Access Memory), a ROM (Read Only Memory), and a flash memory. Each of the storage units (the learning data storage unit 105, the setting parameter storage unit 106, and the model parameter storage unit 107) included in the estimation apparatus 10 can be implemented by using the memory device 206. In addition, at least one storage unit among each of the storage units included in the estimation apparatus 10 may be implemented by a storage device (for example, database server or the like) which is connected to the estimation apparatus 10 via the communication network.

The estimation apparatus 10 according to the present embodiment can implement the estimation processing described above by having the hardware configuration illustrated in FIG. 3. The hardware configuration illustrated in FIG. 3 is merely an example, and the estimation apparatus 10 may have a different hardware configuration. For example, the estimation apparatus 10 may have a plurality of processors 205 and may have a plurality of memory devices 206.

The present invention is not limited to the embodiment specifically disclosed above, and various modifications, changes, combinations with known techniques, and the like can be made without departing from the scope of the claims.

### REFERENCE SIGNS LIST

10 Estimation apparatus
101 Learning data storing unit
102 Setting parameter storing unit
103 Model parameter estimation unit
104 Transition probability estimation unit
105 Learning data storage unit
106 Setting parameter storage unit
107 Model parameter storage unit
201 Input device
202 Display device
203 External I/F
203a Recording medium
204 Communication I/F
205 Processor
206 Memory device
207 Bus

1. A computer implemented method for estimating a parameter of a model for obtaining a state transition probability used in model-based reinforcement learning, comprising:
receiving as an input:
first data indicating a state transition history when a first action of the model-based reinforcement learning is not performed, and
second data indicating, when a second action prompting a transition to a predetermined state is performed, a degree of accepting the transition to the predetermined state are input; and
estimating a parameter of the model using the first data and the second data.

2. The computer implemented estimation method according to claim 1, wherein
the second data is represented by a tuple of at least one of a state and time, the action prompting a transition to the predetermined state, and a probability indicating the degree of accepting a transition to the predetermined state.

3. The computer implemented method according to claim 2, wherein
the parameter of the model is θ={u,v}, and wherein
the model includes:
a first model in which, when an action of the model-based reinforcement learning is not performed, a probability of transitioning to a state is defined by a parameter u,
a second model in which, when an action of the model-based reinforcement learning is performed, a probability of transitioning to a state of a transition destination prompted by the action is defined by parameters u and v, and
a third model in which, when an action of the model-based reinforcement learning is performed, a probability of transitioning to a state other than a state of a transition destination prompted by the action is defined by parameters u and v.

4. The computer implemented method according to claim 3, wherein
the estimating further comprises estimating a parameter of the model by optimizing an objective function including a first generation probability of the first data and a second generation probability of the second data, and wherein
the first generation probability of the first data is calculated by the first model and the second generation probability of the second model is calculated by the second model and the third model.

5. An estimation apparatus that estimates a parameter of a model for obtaining a state transition probability used in model-based reinforcement learning, the estimation apparatus comprising a processor configured to execute a method comprising:
receiving as input first data indicating a state transition history in a situation where a first action of the model-based reinforcement learning is not performed and second data indicating, when a second action prompting a transition to a predetermined state is performed, a degree of accepting the transition to the predetermined state; and
estimating a parameter of the model by using the first data and the second data.

6. A computer-readable non-transitory recording medium storing computer-executable program instructions that when executed by a processor cause for causing a computer to execute a method for estimating a parameter of a model for obtaining a state transition probability used in model-based reinforcement learning, comprising:
receiving as an input:
first data indicating a state transition history when a first action of the model-based reinforcement learning is not performed, and
second data indicating, when a second action prompting a transition to a predetermined state is performed, a degree of accepting the transition to the predetermined state are input; and
estimating a parameter of the model using the first data and the second data.

7. The computer implemented method according to claim 1, wherein the model-based reinforcement learning corresponds to learning the model associated with adaptive control of traffic lights.

8. The computer implemented method according to claim 1, wherein the model-based reinforcement learning corresponds to learning the model associated with a healthcare application notifying an activity indicating the transition to a predetermined state associated with a health.

9. The estimation apparatus according to claim 5, wherein
the second data is represented by a tuple of at least one of a state and time, the action prompting a transition to the predetermined state, and a probability indicating the degree of accepting a transition to the predetermined state.

10. The estimation apparatus according to claim 9, wherein
the parameter of the model is θ={u,v}, and wherein
the model includes:
a first model in which, when an action of the model-based reinforcement learning is not performed, a probability of transitioning to a state is defined by a parameter u,
a second model in which, when an action of the model-based reinforcement learning is performed, a probability of transitioning to a state of a transition destination prompted by the action is defined by parameters u and v, and
a third model in which, when an action of the model-based reinforcement learning is performed, a probability of transitioning to a state other than a state of a transition destination prompted by the action is defined by parameters u and v.

11. The estimation apparatus according to claim 10, wherein
the estimating further comprises estimating a parameter of the model by optimizing an objective function including a first generation probability of the first data and a second generation probability of the second data; and wherein
the first generation probability of the first data is calculated by the first model and the second generation probability of the second model is calculated by the second model and the third model.

12. The estimation apparatus according to claim 5, wherein the model-based reinforcement learning corresponds to learning the model associated with adaptive control of traffic lights.

13. The estimation apparatus according to claim 5, wherein the model-based reinforcement learning corresponds to learning the model associated with a healthcare application notifying an activity indicating the transition to a predetermined state associated with a health.

14. The computer-readable non-transitory recording medium according to claim 6, wherein
the second data is represented by a tuple of at least one of a state and time, the action prompting a transition to the predetermined state, and a probability indicating the degree of accepting a transition to the predetermined state.

15. The computer-readable non-transitory recording medium according to claim 14, wherein
the parameter of the model is θ={u,v}, and wherein
the model includes:
a first model in which, when an action of the model-based reinforcement learning is not performed, a probability of transitioning to a state is defined by a parameter u,
a second model in which, when an action of the model-based reinforcement learning is performed, a probability of transitioning to a state of a transition destination prompted by the action is defined by parameters u and v, and
a third model in which, when an action of the model-based reinforcement learning is performed, a probability of transitioning to a state other than a state of a transition destination prompted by the action is defined by parameters u and v.

16. The computer-readable non-transitory recording medium according to claim 15, wherein
the estimating further comprises estimating a parameter of the model by optimizing an objective function including a first generation probability of the first data and a second generation probability of the second data; and wherein
the first generation probability of the first data is calculated by the first model and the second generation probability of the second model is calculated by the second model and the third model.

17. The computer-readable non-transitory recording medium according to claim 6, wherein the model-based reinforcement learning corresponds to learning the model associated with adaptive control of traffic lights.

18. The computer-readable non-transitory recording medium according to claim 6, wherein the model-based reinforcement learning corresponds to learning the model associated with a healthcare application notifying an activity indicating the transition to a predetermined state associated with a health.
